(19) United States
(12) Patent Application Publication
(10) Pub. No.: US 2022/0198484 A1
(43) Pub. Date: Jun. 23, 2022

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventors: Yui SUGIE, Nagoya-shi (JP); Koichi SUZUKI, Miyoshi-shi (JP); Naoki UENOYAMA, Nagoya-shi (JP); Hiroki TAKEDA, Okazaki-shi (JP); Hirohiko MORIKAWA, Toyota-shi (JP); Genshi KUNO, Kasugai-shi (JP)

(73) Assignee: TOYOTA JIDOSHA KABUSHIKI KAISHA, Toyota-shi (JP)

(21) Appl. No.: 17/507,528

(22) Filed: Oct. 21, 2021

(30) Foreign Application Priority Data
Dec. 23, 2020 (JP) 2020-214289

(51) Int. Cl. G06Q 30/02; G06Q 50/26

(52) U.S. Cl. CPC G06Q 30/0202; G06Q 10/087; G06Q 50/265

(57) ABSTRACT

An information processing device includes a communication unit and a control unit. The communication unit is configured to be able to acquire purchase information indicating that a user has purchased a predetermined item. The control unit is configured to be able to accumulate the purchase information and determine a satisfaction level of a predetermined requirement for sheltering in a vehicle that is used as an evacuation shelter based on the purchase information that has been accumulated. The predetermined item is an item that is available for sheltering in the vehicle when a disaster occurs.

### CROSS-REFERENCE TO RELATED APPLICATION

This application claims priority to Japanese Patent Application No. 2020-214289 filed on Dec. 23, 2020, incorporated herein by reference in its entirety.

### BACKGROUND

### 1. Technical Field

The present disclosure relates to an information processing device, an information processing method, and a program.

### 2. Description of Related Art

In the event of a disaster such as an earthquake and a hurricane, a vehicle may be used as an evacuation shelter in addition to evacuation shelters designated by a local government etc. For example, Japanese Unexamined Patent Application Publication No. 2020-6908 (JP 2020-6908 A) discloses an accommodation vehicle that includes a mechanism capable of reclining a seat as compared with a normal use when the vehicle is used for accommodation. Such a vehicle can be used for sheltering in a vehicle in the event of a disaster. In addition, a set of items for sheltering in the vehicle is sold as a product. The set of items is designed assuming that the vehicle is used as the evacuation shelter.

### SUMMARY

However, sheltering in a vehicle for a long period of time may lead to risks. For example, when users sit in the same posture for a long period of time and limit the intake of water, there may be a risk of venous thromboembolism that is so-called economy class syndrome. Further, the users may suffer from heat stroke, dehydration, hypothermia, etc., depending on an environment around the vehicle. In addition, stopping the vehicle in a closed space and keeping an engine running may result in oxygen deficiency. For this reason, a local government etc. may hope to provide information on the risk to the users who may shelter in the vehicle. Further, in a case where the users shelter in the vehicle, it is desirable to provide various information to the users and improve convenience for them.

The purpose of the present disclosure made in view of such circumstances is to predict the users who need to be provided with information on sheltering in the vehicle.

In order to solve the above issue, an information processing device according to the embodiment of the present disclosure includes a communication unit and a control unit. The communication unit is configured to be able to acquire purchase information indicating that a user has purchased a predetermined item. The control unit is configured to be able to accumulate the purchase information and determine a satisfaction level of a predetermined requirement for sheltering in a vehicle that is used as an evacuation shelter based on the purchase information that has been accumulated. The predetermined item is an item that is available for sheltering in the vehicle when a disaster occurs.

In order to solve the above issue, an information processing method according to the embodiment of the present disclosure includes acquiring purchase information indicating that a user has purchased a predetermined item by a communication unit, accumulating the purchase information by a control unit, and determining by the control unit, based on the purchase information that has been accumulated, a satisfaction level of a predetermined requirement for sheltering in a vehicle that is used as an evacuation shelter. The predetermined item is an item that is available for sheltering in the vehicle when a disaster occurs.

In order to solve the above issue, a program according to the embodiment of the present disclosure causes a computer to perform: acquiring purchase information indicating that a user has purchased a predetermined item; accumulating the purchase information; and determining, based on the purchase information that has been accumulated, a satisfaction level of a predetermined requirement for sheltering in a vehicle that is used as an evacuation shelter. The predetermined item is an item that is available for sheltering in the vehicle when a disaster occurs.

According to the present disclosure, it is possible to provide an information processing device, an information processing method, and a program that are capable of predicting a user who needs to be provided with information on sheltering in a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of an information processing system including an information processing device according to an embodiment of the present disclosure;

FIG. 2 is a block diagram showing a schematic configuration of the information processing device in FIG. 1;

FIG. 3 is a flowchart of processing that is executed by the information processing device according to the present disclosure and that evaluates a satisfaction level of a requirement for sheltering in a vehicle and a possibility of sheltering in a vehicle;

FIG. 4 is a flowchart of processing executed by the information processing device when an information provision request is received from an outside source; and

FIG. 5 is a flowchart of processing executed by the information processing device when information on items in short supply is provided to users.

### DETAILED DESCRIPTION OF EMBODIMENTS

Hereinafter, an embodiment of the present disclosure will be described below with reference to the drawings.

System Overview

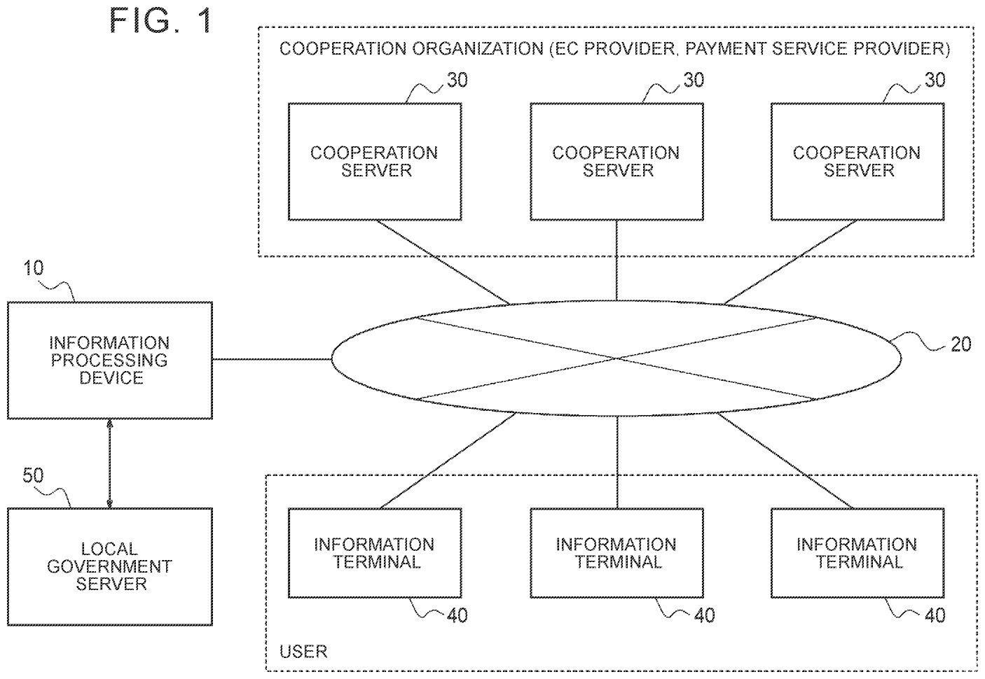

As shown in FIG. 1, an information processing device 10 according to the embodiment of the present disclosure is configured to be able to communicate with one or more cooperation servers 30 and one or more information terminals 40 via a network 20.

The information processing device 10 is composed of one or more computers. The information processing device 10 may provide various services to a user who accesses information via the network 20 using the information terminal 40. The services may be provided, for example, as membership services to the user of a vehicle.

The information processing device 10 can acquire purchase information indicating that the user has purchased an item from the cooperation server 30, and provide the information to the user's information terminal 40 based on the purchase information. In order to acquire the purchase information from the cooperation server 30, the information processing device 10 receives, from the user, permission regarding information acquisition in advance.

The information processing device 10 may give an incentive such as giving a discount or points to the user when the user purchases the item using the information terminal 40 in the cooperation server 30 via the information processing device 10. In this case, the information processing device 10 may directly acquire the purchase information. The information processing device 10 may acquire, from the cooperation server 30, search information on the item the user has searched. It is not essential that the information processing device 10 acquires the search information.

The network 20 may include various networks that include a public network such as the Internet, a virtual private network (VPN), a 4th generation mobile communication system (4G), and a 5th generation mobile communication system (5G). The network 20 may be connected to the information processing device 10, the cooperation server 30, and the information terminals 40 by various wired and wireless access means.

The cooperation server 30 is one or more computers. The cooperation server 30 includes a product sales web site that sells products via a communication network, and a server of a payment service provider that provides a payment service. The product sales website is, for example, a virtual store on the Internet and a virtual shopping mall. The product sales website can provide information on products to be sold in a searchable manner to the user who accesses the website via the network 20 using the information terminal 40. The product sales website allows the search information on products searched by the user and the purchase information for a case of actually purchasing the products to be collected. The payment service provider includes credit card companies and providers that provide electronic payment services. The payment service provider can collect the purchase information of the user.

The information terminal 40 is an information device owned by the user who uses the service provided by the information processing device 10. The information terminal 40 includes a mobile phone (smartphone), a personal computer, and an in-vehicle information device mounted on the vehicle. The information terminal 40 includes a processor, a display device, an input device, and a storage device. The user can register information in the information processing device 10 using the information terminal 40 and receive various types of information from the information processing device 10. In addition, the user can access the cooperation server 30 of the product sales website by using the information terminal 40 to search for product information and purchase items.

Further, the information processing device 10 may be configured to be able to communicate with an external server such as a local government server 50 owned by the local government. The information processing device 10 and the local government server 50 may communicate with each other via the network 20 or other communication means.

Configuration of Information Processing Device

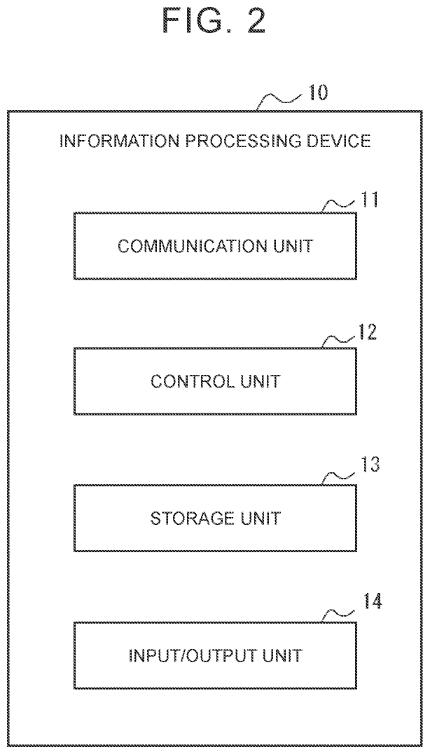

FIG. 2 shows a schematic configuration of the information processing device 10. The information processing device 10 includes a communication unit 11, a control unit 12, a storage unit 13, and an input/output unit 14.

The communication unit 11 includes a communication module connected to the network 20. The communication module may include a communication module supporting various communication standards such as a wired local area network (LAN), a wireless LAN, an optical communication line, and a digital subscriber line. The communication unit 11 can perform protocol processing related to information transmission and reception, and processing such as modulation of a transmission signal and demodulation of a reception signal. The information processing device 10 is connected to the network 20 by the communication unit 11.

The control unit 12 is configured to include a single processor or a plurality of processors. The processor includes a general-purpose processor that executes a programmed function by loading a program, and a dedicated processor that is dedicated for specific processing. As the dedicated processor, a digital signal processor (DSP), an application specific integrated circuit (ASIC), a field-programmable gate array (FPGA) and the like can be adopted. The control unit 12 may be further configured to include a memory.

The control unit 12 controls the operation of the information processing device 10 as a whole. The processing executed by the information processing device 10 can be regarded as the processing executed by the control unit 12. The control unit 12 can transmit and receive information to and from the cooperation server 30 and the information terminal 40 via the communication unit 11. Hereinafter, the control unit 12 transmitting or receiving the information via the communication unit 11 may be described as the control unit 12 transmitting or receiving the information.

The storage unit 13 can store any information and program used in the processing of the information processing device 10. The storage unit 13 may include a semiconductor storage device, a magnetic storage device, and an optical storage device. The semiconductor storage device may include a memory such as a read only memory (ROM), a random access memory (RAM), and a flash memory. The storage unit 13 may store user identification information that identifies the user and information registered by each user.

The input/output unit 14 may include a display and a keyboard, or a touch panel, etc. The input/output unit 14 is used by an administrator or an operator of the information processing device 10 for operating the information processing device 10, inputting commands, and the like.

The control unit 12 can accept registration from the user's information terminal 40 via the communication unit 11. When the user registration is performed, the control unit 12 can acquire user information on the user from the information terminal 40. The user information may include, for example, one or more pieces of information on a vehicle owned by the user, information on age and gender of the user, information on the number of family members of the user, and information on whether the user has a pet. The control unit 12 may accept a part of the input of the user information from the input/output unit 14.

The control unit 12 stores in the storage unit 13 the purchase information indicating that the user has purchased a predetermined item. The predetermined item is an item that can be used for sheltering in the vehicle in the event of a disaster. Examples of the predetermined item include one or more, two or more, four or more, or eight or more of cushions, vehicle mats, vehicle tents that can be connected to the vehicle, sleeping bags, sunshades, vehicle curtains, portable power supplies, small generators, a simple toilet that can be mounted on the vehicle, preserved foods, stored water, in-vehicle refrigerators, cold boxes, portable gas stoves, and electric water heaters. The predetermined item may include a set of items for sheltering in the vehicle, the set of items being a collection of a set of items required for sheltering in the vehicle. The items described above are examples. The predetermined item may further include a large number of items that can be used for sheltering in the vehicle. For example, the predetermined item may include an insect repellent net for the vehicle, a lantern that does not consume a battery of the vehicle, and the like. The administrator or the operator of the information processing device 10 can register and change the predetermined item.

The control unit 12 can determine, based on the accumulated purchase information, a satisfaction level of a predetermined requirement for sheltering in the vehicle. Examples of the predetermined requirement include one or more requirements of comfort, privacy protection, energy security, toilets, food and water, and the like. The predetermined requirement includes at least a requirement for comfort. The predetermined requirement may include all the requirements of comfort, privacy protection, energy security, toilets, and food and water. The satisfaction level of the predetermined requirement can be used as an index indicating the entire satisfaction level of the predetermined requirement. Further, the satisfaction level of the predetermined requirement may be information indicating whether each requirement included in the predetermined requirement is satisfied.

Table 1 shows an example of the correspondence between the predetermined requirement and the predetermined item. The predetermined requirement and the predetermined item shown in Table 1 are examples. The predetermined requirement and the predetermined item are not limited to these.

TABLE 1

| Predetermined requirement | Predetermined item |
|---|---|
| Comfort | Cushion |
| | Vehicle mat |
| | Vehicle tent |
| | Sleeping bag |
| Privacy protection | Sunshade |
| | Vehicle curtain |
| Energy security | Portable power supply |
| | Small generator |
| Toilet | Portable toilet (assembled toilet) |
| Food and water | Preserved food |
| | Stored water |
| | In-vehicle refrigerator |
| | Cold box |
| | Portable gas stove |
| | Electric water heater |
| — | Set of items for sheltering in vehicle (set of |
| | items for sheltering) |

The requirement for ensuring comfort is a requirement regarding comfort when the vehicle is used as an evacuation shelter. For example, the requirement includes being able to take a comfortable posture, lie down, etc. in a vehicle cabin. The users may suffer from economy class syndrome when it is difficult to stretch their legs and change their postures in the vehicle cabin. The requirement for comfort includes taking measures for the economy class syndrome. Items related to the requirement for comfort include cushions, vehicle mats, vehicle tents, and sleeping bags. When purchase information for these items is accumulated, the requirement for comfort is at least partially satisfied.

The requirement for protecting privacy is a requirement for protecting privacy during sheltering in the vehicle. The requirement for protecting privacy is related to sunshades, vehicle curtains, etc. among the predetermined items.

The requirement for securing energy is a requirement for taking measures for energy security for sheltering in the vehicle for a long period of time. When an air conditioner, lamps, and other electrical devices are used using the battery in the vehicle, gasoline that is used for the battery and for charging the battery is consumed, which may lead to shortage of energy. A portable power supply and a small generator can supply electric power without consuming the energy of the vehicle. When these items are included in the purchase information, the requirement for securing energy is at least partially satisfied.

The requirement for the toilet is a requirement for providing a toilet during sheltering in the vehicle. For example, a movable portable toilet or an assembled toilet are related to this requirement.

The requirement for the food and water indicates availability of food and water for several days assuming that food and water are not provided. The preserved food and the stored water among the predetermined items are related to this requirement. The in-vehicle refrigerator and the cold box are useful for securing a food since foods in a refrigerator at home can be moved and stored there. The portable gas stove and electric water heater are useful for securing a food since these items can be used for cooking when instant foods are stored at home. Therefore, when these items are available, the requirement for securing the food and water is at least partially satisfied.

When the user purchases the set of items for sheltering in the vehicle, correspondence between items included in the set and respective requirements is evaluated. Such an evaluation may be registered in advance in the information processing device 10 for each commercially available set of items for sheltering in the vehicle.

The predetermined requirement is not limited to the five requirements of comfort, privacy protection, energy security, toilets, and food and water, but includes a requirement in which the predetermined requirement is prescribed in different expressions, a requirement in which a part of the predetermined requirement is further divided into a plurality of requirements, a requirement in which details of the predetermined requirement are rearranged, etc.

The control unit 12 can predict a user who needs to be provided with information on sheltering in the vehicle based on the satisfaction level of the predetermined requirement in normal times when a disaster does not occur. The control unit 12 may select items that are expected to be short in supply when the users shelter in the vehicle due to the disaster, and transmit information on the items to the information terminal 40 owned by the user. For example, when it is determined that the user has not purchased the vehicle mat based on the purchase information, the control unit 12 may transmit information recommending purchase of the vehicle mat to the information terminal 40. If the user has a vehicle mat, the user may operate the information terminal 40 and transmit information indicating that the user has the vehicle mat to the information processing device 10. As a result, the information processing device 10 may add the vehicle mat to the purchase information as an item purchased by the user.

When a disaster occurs, the control unit 12 may transmit advice information to the user's information terminal 40 based on the satisfaction level of the predetermined requirement. For example, when the satisfaction level of the predetermined requirement is high, the control unit 12 can transmit, to the user's information terminal 40, advice information recommending the user to shelter in the vehicle. In addition, when a part of the predetermined requirement is not satisfied, the control unit 12 may transmit, to the user's information terminal 40, advice information according to the insufficient requirement. For example, when the user does not have the purchase information of the portable toilet, the control unit 12 can transmit the advice information recommending the user to shelter in the vehicle near the evacuation shelter where the toilet can be used.

The control unit 12 may evaluate the possibility of sheltering in the vehicle that is a possibility that the user shelters in the vehicle, based on the satisfaction level of the predetermined requirement described above. The control unit 12 may evaluate the possibility of sheltering in the vehicle based on the user information acquired in advance, in addition to the satisfaction level of the predetermined requirement. The evaluation of the possibility of sheltering in the vehicle may be performed by scoring conditions that presumes the user selects sheltering in the vehicle, and calculating an index obtained by adding the scores. For example, when the satisfaction level of the predetermined requirement is high, it is presumed that the possibility of sheltering in the vehicle is high, so that a high score is given. In addition, when the vehicle owned by the user is a type of vehicle in which the seat back of rear seats can be tilted to the floor position, it is presumed that the possibility of sheltering in the vehicle is high, so that a high score is given. Also, when the user has a pet, it is presumed that the possibility of sheltering in the vehicle is high since the evacuation shelter often does not accept pets, so that a high score is given.

The evaluation of the possibility of sheltering in the vehicle may be performed by another method instead of scoring described above. For example, the satisfaction level of the above requirement and user information, and information on an evacuation method selected by the user when the disaster occurs may be accumulated, and the possibility of sheltering in the vehicle may be evaluated by machine learning. The index for evaluating the possibility of sheltering in the vehicle is not necessarily expressed by the score described above. The index for evaluating the possibility of sheltering in the vehicle may be expressed as a percentage for probability. The index indicating the possibility of sheltering in the vehicle may be expressed by a binary value corresponding to a high possibility or a low possibility. Alternatively, the index indicating the possibility of sheltering in the vehicle may be expressed by a five stage evaluation process.

When evaluating the possibility that the user shelters in the vehicle, the control unit 12 may check information on whether the user's purchase information includes the set of items for sheltering in the vehicle. A user who has purchased the set of items for sheltering in the vehicle is considered to be highly interested in sheltering in the vehicle. The possibility that the user who has purchased the set of items for sheltering in the vehicle may be evaluated more highly than a case in which a user has not purchased a set of items for sheltering in the vehicle. In addition, the control unit 12 may check the user's search information when evaluating the possibility that the user shelters in the vehicle. When the user searches for the predetermined item that has not been purchased, it is considered that the user is highly interested in sheltering in the vehicle. Therefore, the control unit 12 may evaluate the possibility of sheltering in the vehicle more highly than a case in which the user has not searched for the predetermined item.

The control unit 12 can transmit appropriate information to the user's information terminal 40 according to the possibility of sheltering in the vehicle voluntarily or in response to a request from the outside source such as the local government during normal times and in the event of a disaster.

For example, in normal times when the disaster does not occur, the control unit 12 can receive a request of transmitting, from the local government server 50, reminder information on sheltering in the vehicle to the information terminal 40 of the user whose possibility of sheltering in the vehicle is high. The reminder information may include information for preventing economy class syndrome, information on the intake of water and an appropriate ventilation method, etc. when the user shelters in the vehicle. The control unit 12 may set a threshold value to the index for evaluating the possibility of sheltering in the vehicle, select a user whose possibility of sheltering in the vehicle is higher than the threshold value, and transmit the reminder information to the user's information terminal 40.

In addition, when the disaster occurs, the control unit 12 may provide evacuation information to the information terminal 40 owned by the user based on the possibility of sheltering in the vehicle. The evacuation information includes information for supporting evacuees. For example, the control unit 12 may transmit, to the information terminal 40, information on a location where there is a risk of submersion or fire and the user should not shelter in the vehicle. Further, for example, the control unit 12 may notify the local government or the like of a location where the user shelters in the vehicle. Also, for example, the control unit 12 may transmit information on the scheduled time and location where food, water and evacuation supplies will be provided. The evacuation information may be input to the information processing device 10 from the input/output unit 14 by the operator of the information processing device 10.

Procedure for Determining Satisfaction Level of Requirement for Sheltering in Vehicle and Evaluating Possibility of Sheltering in Vehicle

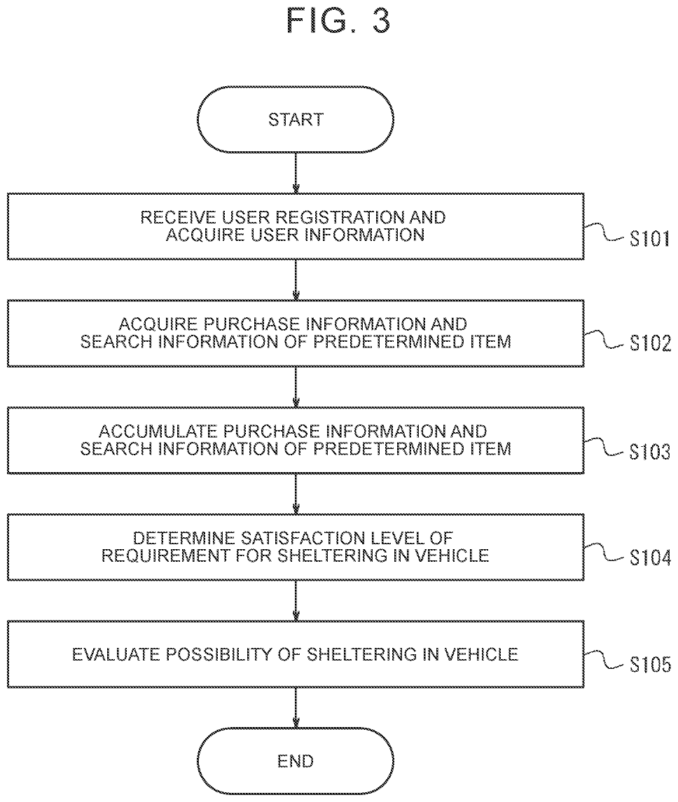

Next, processing executed by the information processing device 10 will be described with reference to the flowchart of FIG. 3.

First, the control unit 12 receives user registration from a user who wishes to use a service provided using the information processing device 10 (step S101). At this time, the user inputs the user information into the information terminal 40. As a result, the control unit 12 acquires the user information. The control unit 12 stores the user information in the storage unit 13. At the time of user registration, the user agrees that purchase information and search information of items are shared with the cooperation server 30 and the information processing device 10. The user directly transmits, to the cooperation server 30, information for permitting the information to be shared from the information terminal 40 as necessary. The information processing device 10 establishes a state of information linkage with the cooperation server 30. As a result, the purchase information and the search information that the user has permitted to be shared with the cooperation server 30 is transmitted to the information processing device 10.

The control unit 12 sequentially acquires the purchase information and the search information of the predetermined items from the cooperation server 30 via the communication unit 11 (step S102). The control unit 12 may acquire the purchase information and the search information from a plurality of cooperation servers 30. The control unit 12 may acquire the purchase information and the search information every time the user purchases or searches for a product in the cooperation server 30. Alternatively, the control unit 12 may acquire the purchase information and the search information as information collected for a predetermined period.

The control unit 12 accumulates the purchase information and the search information of the specific item in the storage unit 13 (step S103).

The control unit 12 determines the satisfaction level of the requirement for sheltering in the vehicle based on the purchase information stored in the storage unit 13 (step S104). The satisfaction level of the requirement for sheltering in the vehicle for each user may be stored in the storage unit 13.

Further, the control unit 12 evaluates the possibility of sheltering in the vehicle based on the satisfaction level of the requirement for sheltering in the vehicle determined in step S104 and the user information registered in advance (step S105). When the user's purchase information includes the set of items for sheltering in the vehicle, and when the user's search information includes the search information of the predetermined item, the possibility of sheltering in the vehicle is evaluated more highly. The evaluation for the possibility that each user shelters in the vehicle may be stored in the storage unit 13.

The control unit 12 may periodically execute steps S104 and S105. Steps S104 and S105 may be executed by using, as a trigger, reception of a request from the outside source such as the local government via the communication unit 11 or an input of a command from the input/output unit 14.

Providing Information to User 1

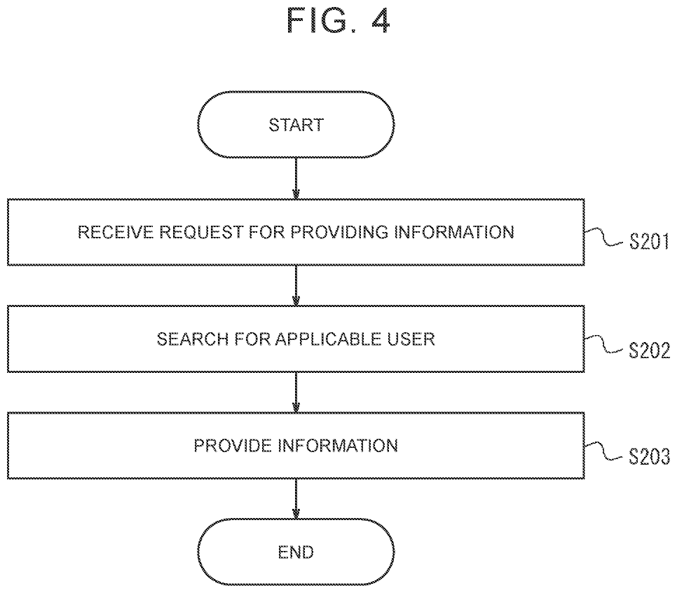

Next, with reference to FIG. 4, processing of the control unit 12 when a request for providing information from the outside source such as the local government to the user is received will be described.

First, the control unit 12 receives a request for providing information from the local government server 50 via the communication unit 11 (step S201). For example, a case is assumed in which the local government announces in advance precautions for sheltering in the vehicle to a user who is expected to select sheltering in the vehicle when a disaster occurs.

The control unit 12 searches for a user to be provided with information based on the user's purchase information, the user information, and the search information stored in the storage unit 13 (step S202). For example, the control unit 12 selects, from the storage unit 13, a user whose possibility of sheltering in the vehicle is high.

The control unit 12 transmits, to the information terminal 40, information received from the local government via the communication unit 11 (step S203). As a result, it is possible to efficiently provide in advance information such as risks associated with sheltering in the vehicle and measures for the risks to the user who may shelter in the vehicle in the event of a disaster.

Providing Information to User 2

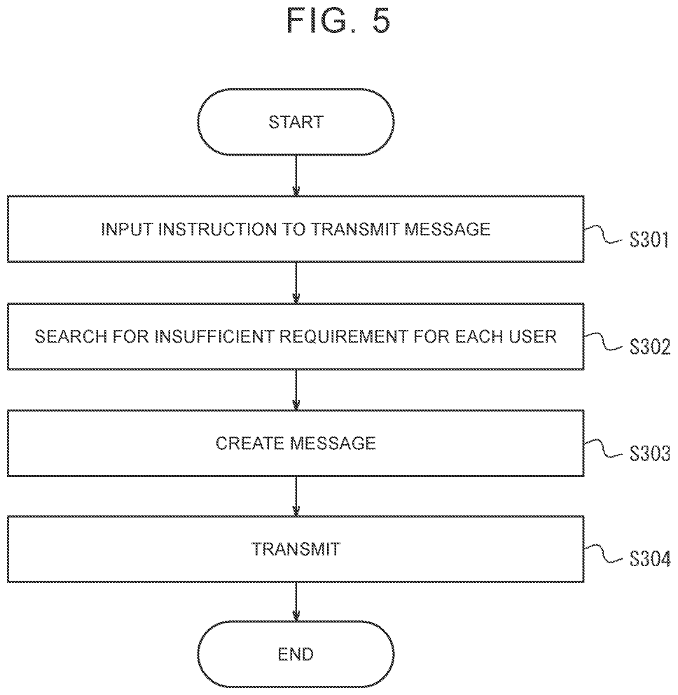

Next, with reference to FIG. 5, processing for providing the user with information on items in short supply for sheltering in the vehicle from the operator of the information processing device 10 will be described.

First, the operator of the information processing device 10 inputs an instruction to the information processing device 10 using the input/output unit 14 such that information of the items in short supply is provided to a user (step S301). Note that such an instruction may be programmed in the information processing device 10 so as to be periodically transmitted to the user.

Upon receiving the input of the above instruction, the control unit 12 searches for an insufficient requirement for sheltering in the vehicle for each user based on the user's purchase information stored in the storage unit 13 (step S302).

The control unit 12 creates a message including information on an item for which purchase is recommended based on the insufficient requirement for each user (step S303).

The control unit 12 transmits the created message via the communication unit 11 (step S304). As a result, the user can purchase in advance the item that will be necessary in the event of a disaster and prepare for the disaster.

FIGS. 4 and 5 are flowcharts of providing information in normal times when a disaster does not occur. The information processing device 10 can provide appropriate information to the user who is expected to shelter in the vehicle even in the event of a disaster.

As described above, with the information processing device 10 according to the present disclosure, the control unit 12 can acquire the purchase information of the user and store the information in the storage unit 13. As a result, the information processing device 10 can determine the satisfaction level of the requirement required when the user shelters in the vehicle, and can predict the user who needs to be provided with information on sheltering in the vehicle. The information processing device 10 can transmit useful information to the user who needs to be provided with information. Further, the control unit 12 evaluates the possibility that the user shelters in the vehicle based on the satisfaction level of the requirement, or the satisfaction level of the requirement and the user information. As a result, the information processing device 10 can transmit, to the user whose possibility of sheltering in the vehicle is high, the reminder information and the like in a case of sheltering in the vehicle. Further, when the information is transmitted via the information processing device 10, the local government or the like can transmit, to the user who shelters in the vehicle, an appropriate message to support the user in the event of a disaster. Further, the information processing device 10 can acquire the search information of the user, which improves accuracy for presuming the possibility of sheltering in the vehicle.

The present disclosure is not limited to the above embodiment, and many modifications or alternations can be made. For example, the functions included in each means, each step, etc. can be rearranged so as not to be logically inconsistent, and a plurality of means, steps, etc. can be combined into one or divided. The information processing method disclosed by the flowchart of the present specification can be executed by causing the processor included in the information processing device 10 to execute a program. Such a program can be stored in a non-transitory computer-readable medium. Examples of the non-transitory computer-readable medium include hard disks, RAMs, ROMs, flash memories, compact disc (CD)-ROMs, optical storage devices, magnetic storage devices, and the like, but are not limited to these.

What is claimed is:

1. An information processing device comprising:
a communication unit configured to be able to acquire purchase information indicating that a user has purchased a predetermined item; and
a control unit configured to be able to accumulate the purchase information and determine a satisfaction level of a predetermined requirement for sheltering in a vehicle that is used as an evacuation shelter based on the purchase information that has been accumulated, wherein the predetermined item is an item available for sheltering in the vehicle when a disaster occurs.

2. The information processing device according to claim 1, wherein the communication unit is configured to be able to acquire the purchase information from one or both of a product sales website that sells a product via a communication network and a payment service provider.

3. The information processing device according to claim 1, wherein the predetermined item includes at least one or more of a cushion, a vehicle mat, a vehicle tent that is able to be connected to the vehicle, a sleeping bag, a sunshade, a vehicle curtain, a portable power supply, a small generator, a portable toilet, a preserved food, stored water, an in-vehicle refrigerator, a cold box, a portable gas stove, and an electric water heater.

4. The information processing device according to claim 1, wherein the predetermined requirement includes a requirement regarding at least any one of comfort, privacy protection, energy security, a toilet, and a food and water.

5. The information processing device according to claim 1, wherein the predetermined requirement includes a requirement regarding all of comfort, privacy protection, energy security, a toilet, and a food and water.

6. The information processing device according to claim 4, wherein the requirement for the comfort includes taking a measure for economy class syndrome.

7. The information processing device according to claim 1, wherein based on the purchase information that has been accumulated, the control unit is configured to be able to select an item that is expected to be in short supply when the user shelters in the vehicle in a case of a disaster, and transmit, to an information terminal owned by the user, information on the item in short supply.

8. The information processing device according to claim 1, wherein when a disaster occurs, the control unit provides evacuation information to an information terminal owned by the user based on the satisfaction level.

9. The information processing device according to claim 1, wherein the control unit evaluates a possibility of sheltering in the vehicle that is a possibility that the user shelters in the vehicle, based on the satisfaction level of the predetermined requirement.

10. The information processing device according to claim 9, wherein the control unit acquires in advance, as user information, at least one or more pieces of information on a vehicle owned by the user, information on age and gender of the user, information on the number of family members of the user, and information on whether the user has a pet, and in addition to the satisfaction level of the predetermined requirement, evaluates the possibility of sheltering in the vehicle based on the user information.

11. The information processing device according to claim 10, wherein:
the communication unit is able to acquire search information on a product searched by the user via a communication network; and
the control unit further checks the search information on the product and evaluates the possibility of sheltering in the vehicle.

12. The information processing device according to claim 9, wherein the predetermined item includes a set of items for sheltering in the vehicle, the set of items being a collection of items required for sheltering in the vehicle, and when the purchase information of the user includes the set of items for sheltering in the vehicle, the control unit evaluates the possibility of sheltering in the vehicle more highly.

13. The information processing device according to claim 9, wherein the control unit is configured such that, in normal times when a disaster does not occur, the control unit is able to select the user based on evaluation of the possibility of sheltering in the vehicle, and transmit information on sheltering in the vehicle to an information terminal owned by the user.

14. The information processing device according to claim 9, wherein when a disaster occurs, the control unit provides evacuation information to an information terminal owned by the user based on evaluation of the possibility of sheltering in the vehicle.

15. An information processing method comprising:
acquiring purchase information indicating that a user has purchased a predetermined item by a communication unit;
accumulating the purchase information by a control unit; and
determining by the control unit, based on the purchase information that has been accumulated, a satisfaction level of a predetermined requirement for sheltering in a vehicle that is used as an evacuation shelter, wherein the predetermined item is an item that is available for sheltering in the vehicle when a disaster occurs.

16. The information processing method according to claim 15, wherein the communication unit acquires the purchase information from one or both of a product sales website that sells a product via a communication network and a payment service provider.

17. The information processing method according to claim 15, wherein the predetermined item includes at least one or more of a cushion, a vehicle mat, a vehicle tent that is able to be connected to the vehicle, a sleeping bag, a sunshade, a vehicle curtain, a portable power supply, a small generator, a portable toilet, a preserved food, stored water, an in-vehicle refrigerator, a cold box, a portable gas stove, and an electric water heater.

18. The information processing method according to claim 15, wherein the predetermined item includes at least four of a cushion, a vehicle mat, a vehicle tent that is able to be connected to the vehicle, a sleeping bag, a sunshade, a vehicle curtain, a portable power supply, a small generator, a portable toilet, a preserved food, stored water, an in-vehicle refrigerator, a cold box, a portable gas stove, and an electric water heater.

19. The information processing method according to claim 15, wherein the predetermined requirement includes a requirement regarding at least any one of comfort, privacy protection, energy security, a toilet, and a food and water.

20. A program causing a computer to perform:
acquiring purchase information indicating that a user has purchased a predetermined item;
accumulating the purchase information; and
determining, based on the purchase information that has been accumulated, a satisfaction level of a predetermined requirement for sheltering in a vehicle that is used as an evacuation shelter, wherein the predetermined item is an item that is available for sheltering in the vehicle when a disaster occurs.
